(19) United States
(12) Patent Application Publication
(10) Pub. No.: US 2008/0044624 A1
(43) Pub. Date: Feb. 21, 2008

(54) Complex architecture for dispersing heat

(76) Inventor: Chin-Fu Horng, Lu Chou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/508,978

(22) Filed: Aug. 24, 2006

(30) Foreign Application Priority Data
Aug. 18, 2006 (TW) 95130520

(51) Int. Cl. B32B 3/10

(52) U.S. Cl. 428/138

(57) ABSTRACT

A kind of the complex architecture for dispersing heat includes one graphite device and one metal device with heat conductibility. The metal device, such as copper or aluminum, combines with the graphite device. The metal device transmits heat to the normal direction, and then transmits heat to the horizontal direction by graphite. This design of the complex architecture can transmit and dissipate heat to all regions of the graphite device so that its dissipation efficiency is better.

### BACKGROUND OF THE INVENTION

1. Field of the Invention

The present invention relates to a complex architecture for dispersing heat, and particularly relates to a complex architecture arranged on a heat source for dispersing heat and gaining good dissipation efficiency.

2. Background of the Invention

As the rapid development of the computer technology grows, heat sources, such as central process units, generate more and more heat. Further due to the trendy minimization size, the arisen dense heat should be dissipated out of the system into exterior environment in order to permit the heat source works n in the appropriate temperature. Usually, a heat sink with large contact area is provided to the heat source for transmitting and dispersing the arisen heat.

A conventional heat sink of big volume, made by copper or aluminum, occupies large space, gets heavy weight and has high production cost, obviously it is difficult to meet the requirements of thin, light and short.

Although graphite materials are of conductivity, the heat cannot be transmitted effectively in normal directions because the graphite materials disperse heat in horizontal directions. If the graphite material is applied for heat dissipation, the arisen heat would be transmitted horizontally only and get poor dissipation efficiency.

Hence, an improvement over the prior art is required to overcome the disadvantages thereof.

### SUMMARY OF THE INVENTION

The primary object of the invention is therefore to specify a complex architecture for dispersing heat, which can transmit and dissipate heat to all regions and get excellent dissipation efficiency. In addition, the complex architecture has the production cost reduced, the weight lightened and the volume shrunk.

According to the invention, the object is achieved to provide a complex architecture for dispersing heat, including a graphite device and a metal device with heat conductibility combined with the graphite device.

There are some advantages accomplished according to the present invention, the metal device assembled to the graphite device can transmits heat in normal directions, and then the heat will be further transmitted in horizontal directions by the graphite device. Therefore, the complex architecture can transmit and dissipate heat to all region of the graphite device so that its dissipation efficiency is better. And because of minor application of metal materials, the production cost of the complex architecture will lessen, the weight thereof will lighten and the occupied volume will decrease.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view of a complex architecture for dispersing heat according to a first embodiment of the present invention;

FIG. 2 is a cross-sectional profile of the complex architecture for dispersing heat according to the first embodiment of the present invention;

FIG. 3 is a perspective view of the complex architecture for dispersing heat while in use according to the first embodiment of the present invention;

FIG. 4 is a perspective view of the complex architecture for dispersing heat according to a second embodiment of the present invention;

FIG. 5 is a cross-sectional profile of the complex architecture for dispersing heat according to a third embodiment of the present invention;

FIG. 6 is a perspective view of the complex architecture for dispersing heat according to a fourth embodiment of the present invention;

FIG. 7 is a perspective view of the complex architecture for dispersing heat according to a fifth embodiment of the present invention; and

FIG. 8 is a perspective view of the complex architecture for dispersing heat according to a sixth embodiment of the present invention.

### DETAILED DESCRIPTION OF THE EMBODIMENTS

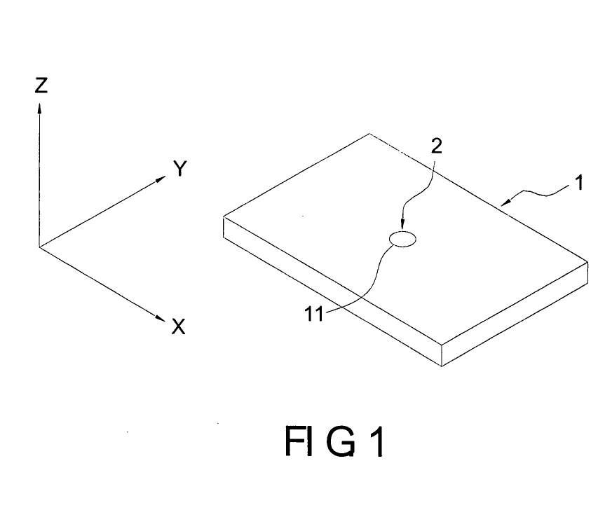

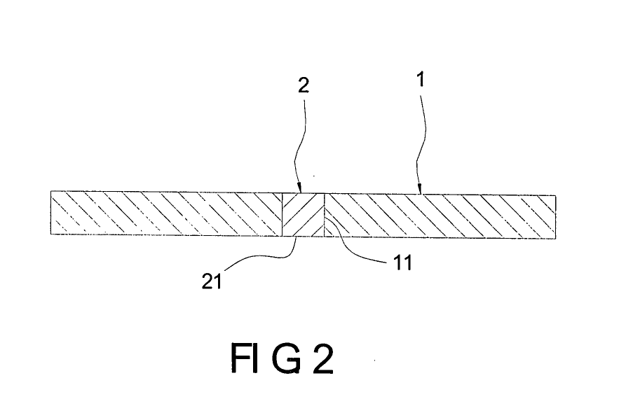

As illustration in FIGS. 1 and 2, a complex architecture for dispersing heat according to the present invention includes a graphite device 1 and a metal device 2 with heat conductivity. The graphite device 1 is made of graphite materials, and is not limited in its shape and dimension. In a first embodiment, the graphite device 1 is rectangular and sheet-liked. The graphite device 1 has a reception cavity 11 formed therein and corresponding to a heat source. The reception cavity 11 can be formed at a middle portion or an edge portion of the graphite device 1. In the first embodiment, the reception cavity 11 is formed at the middle portion of the graphite device. Besides, the reception cavity 11 can be round, rectangular or any other shapes. The graphite device 1 has the reception device 11 penetrated through a top surface to a bottom surface thereof for receiving the metal device 2.

The metal device 2 is of good heat conductivity, such as a copper or aluminum element, and mating with the reception cavity 11 of the graphite device 1. In the first embodiment, the metal device is round for relating to reception cavity 11. The metal device 2 is disposed in the reception cavity 11 fixedly, such as tightly fitting in the reception cavity 11 or bonding to the reception cavity 11 via a heat conductivity medium. The metal device 2 includes a contact portion 21 formed at an end (a bottom end) thereof. The contact portion 21 is exposed out of the bottom surface of the graphite device 1 in order to connect with one kind of heat sources. By these elements mentioned above, the complex architecture for dispersing heat is accomplished.

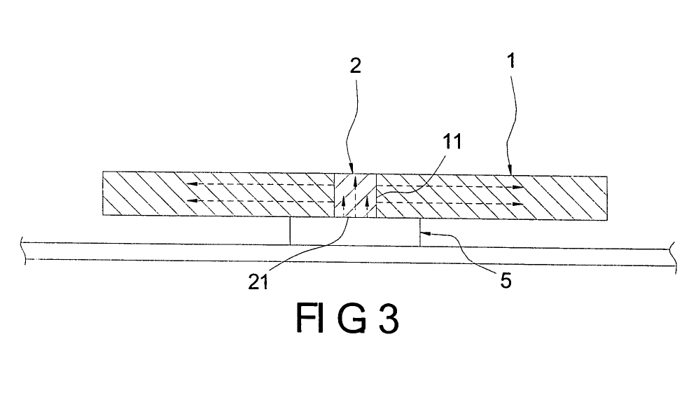

Referring to FIGS. 1 and 3, the complex architecture can be arranged on a heat source 5, such as a central process unit. The contact portion 21 of metal device 2 connects with the heat source 5. There could be a heat conductivity adhesive arranged between the metal device 2 and the heat source 5. The heat arisen from the heat source 5 can be transmitted upwardly along a vertical Z direction via the metal device 2, and then be dispersed transversely along X, Y directions. The arisen heat thereby transmits all regions of the graphite device 1 so that its dissipation efficiency is better.

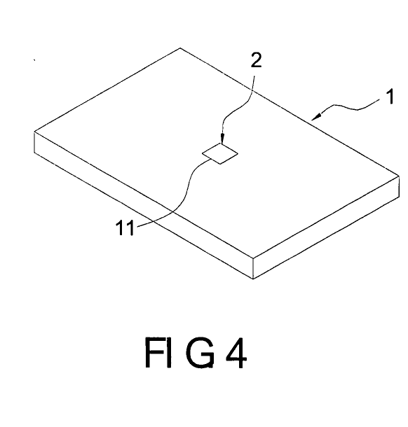

A second embodiment of the present invention illustrated in FIG. 4, the metal device 2 can be rectangular for relating to the corresponding reception cavity 11.

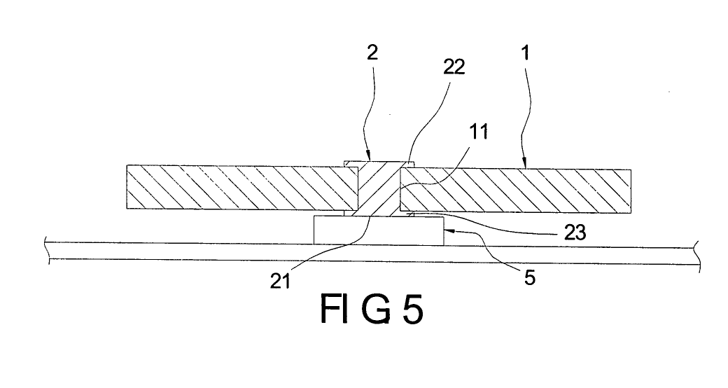

A third embodiment of the present invention illustrated in FIG. 5, the metal device 2 includes two head portions 22, 23 at two opposite ends thereof for retaining against top and bottom surfaces of the graphite device 1 respectively.

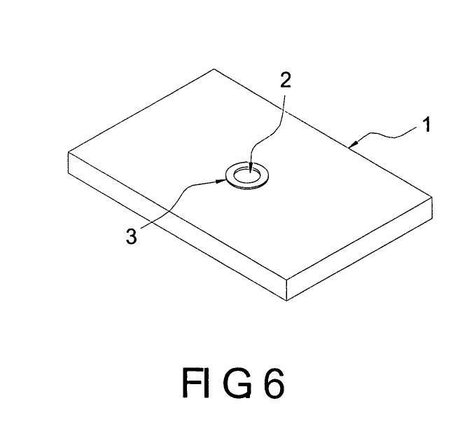

A fourth embodiment of the present invention illustrated in FIG. 6, a sheet element 3, which is circular shaped, is further provided and attached to each of top and bottom surfaces of the graphite device 1. The sheet element 3 joints with the reception cavity 11 and the metal device 2 simultaneously, in order to prevent the lost of the graphite material of the graphite device 1.

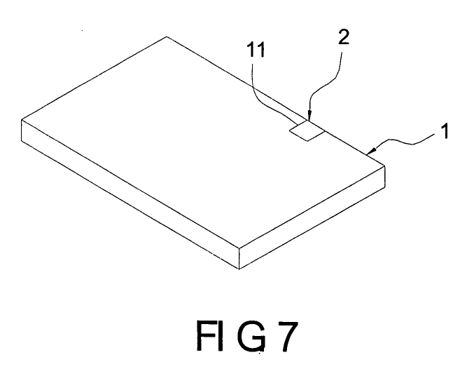

A fifth embodiment of the present invention illustrated in FIG. 7, the reception cavity 11 is formed at the edge portion of the graphite device 1. The metal device 2 can be combined in the reception cavity 11 at the edge portion of the graphite device 1.

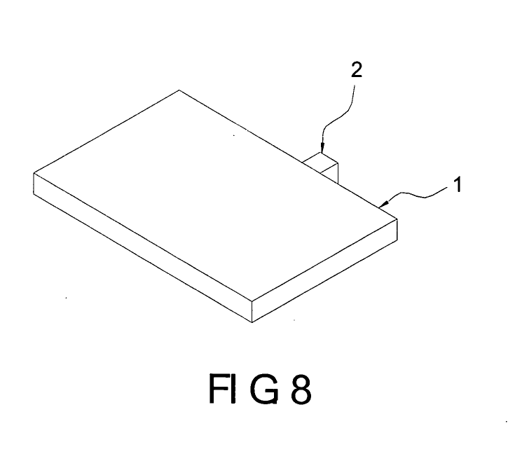

A sixth embodiment of the present invention illustrated in FIG. 8, the metal device 2 can be combined to the edge portion of graphite device 1 directly.

The complex architecture for dispersing heat includes the graphite device 1, and the metal device 2 with heat conductibility combined with the graphite device 1. The metal device 2 transmits heat to the normal direction, and then the graphite device 1 transmits heat to the horizontal direction. This design of the complex architecture can transmit and dissipate heat to all regions of the graphite device so that its dissipation efficiency is better.

In addition, this design of the complex architecture can reduce the production cost, lighten the heavy weight, and shrink the occupied volume.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A complex architecture for dispersing heat, comprising:
a graphite device; and
a metal device with heat conductibility, combined with the graphite device.

2. The complex architecture for dispersing heat as claimed in claim 1, wherein the graphite device includes a reception cavity thereof, and the metal device is disposed in the reception cavity.

3. The complex architecture for dispersing heat as claimed in claim 2, wherein the graphite device has the reception cavity penetrated through a top surface to a bottom surface thereof.

4. The complex architecture for dispersing heat as claimed in claim 2, further including a sheet element attached to each of top and bottom surfaces of the graphite device; wherein the sheet element joints with the reception cavity and the metal device simultaneously.

5. The complex architecture for dispersing heat as claimed in claim 2, wherein the graphite device has the reception cavity formed at a middle portion or an edge portion thereof.

6. The complex architecture for dispersing heat as claimed in claim 1, wherein the metal device is a copper or aluminum element.

7. The complex architecture for dispersing heat as claimed in claim 1, wherein the metal device is combined to an edge portion of the graphite device.

8. The complex architecture for dispersing heat as claimed in claim 1, wherein the metal device includes a contact portion formed at an end thereof.

9. The complex architecture for dispersing heat as claimed in claim 8, further including a heat source connected to the contact portion of the metal device.

10. The complex architecture for dispersing heat as claimed in claim 1, wherein the metal device includes two head portions at two opposite ends thereof for retaining against top and bottom surfaces of the graphite device respectively.

11. The complex architecture for dispersing heat as claimed in claim 1, wherein the metal device tightly fits with the graphite device.
